(19) United States
(12) Patent Application Publication
(10) Pub. No.: US 2024/0141881 A1
(43) Pub. Date: May 2, 2024

(54) ENERGY ACCUMULATOR FOR PISTON-TYPE FUEL PUMP

(71) Applicant: Stanadyne Operating Company LLC, Jacksonville, NC (US)

(72) Inventor: Nicola Fachechi, Royal Oak, MI (US)

(21) Appl. No.: 18/497,297

(22) Filed: Oct. 30, 2023

Related U.S. Application Data
(60) Provisional application No. 63/381,654, filed on Oct. 31, 2022.

(51) Int. Cl. F04B 17/03; F02M 37/04; F02M 37/08

(52) U.S. Cl. CPC F04B 17/03; F02M 37/043; F02M 37/08

(57) ABSTRACT

To reduce the peak torque required by an electric motor-driven high-pressure piston-type fuel pump, a drive assembly between the motor and pump includes an energy accumulator configured to accumulate energy during a low force portion of the pump cycle and return that energy to the pumping plunger during a high force portion of the pump cycle. This arrangement reduces the peak torque required from the motor and allows a smaller, less expensive and less energy intensive electric motor to drive the pump.

### FIELD OF THE INVENTION

The disclosure relates to a high-pressure piston-type fuel pump used to supply pressurized fuel to a direct injection (DI) fuel injection system for an internal combustion engine. In particular, the disclosure relates to a high-pressure fuel pump driven by an electric motor, where the drive accumulates energy during a low-torque portion of a pumping cycle and returns the accumulated energy during a high torque portion of the pumping cycle.

### BACKGROUND

High-pressure piston-type fuel pumps generating fuel pressures in excess of 500 bar require high torque and are commonly driven by a shaft coupled to rotating parts of the engine. This form of drive links the rotational speed of the pump to the rotational speed of the engine, which complicates fuel delivery under some engine operating conditions. For example, when the engine is being started, engine rotational speed is very low and the piston-type pump may take several rotations to generate sufficient fuel pressure. When a vehicle is coasting down a hill, very little fuel is required but the shaft driven fuel pump is still driven by the engine shaft. Since the rotational speed of the DI fuel pump cannot be controlled, DI fuel pumps include metering valves or other systems that control the quantity of pressurized fuel generated by the pump to match fuel delivery to engine operating conditions. Metering valves and other fuel control systems complicate the manufacture and operation of DI fuel pumps, and also increase the cost of DI fuel pumps.

In a shaft driven pump, the shaft rotates a cam or cams that are arranged to reciprocate pumping pistons to alternately expand and restrict the volume of a pumping chamber. Fuel enters the pumping chamber as the piston is withdrawn from the pumping chamber during an intake stroke and fuel is forced out of the pumping chamber under pressure as the piston is driven toward the pumping chamber during a pumping stroke. The torque required to drive the piston during the pumping stroke is much higher than the torque required to retract the piston during the intake stroke. Many DI pumps use pairs of pumping pistons arranged to alternate intake and pumping strokes, so the torque required by the pump is balanced. In many engine platforms, the volume of pressurized fuel can be supplied by a more cost-effective single piston pump, so this torque balancing strategy cannot be used. Further, shaft driven fuel pumps present a significant drag on the engine even when pressurized fuel is not required, reducing the overall efficiency of the engine system.

There is a need for a simplified and cost-effective high-pressure fuel pump that reduces the energy required to provide pressurized fuel.

There is a need for a high-pressure fuel pump having a rotational speed that is independent of the rotational speed of the internal combustion engine.

### SUMMARY OF THE INVENTION

According to aspects of the disclosure, a single-piston fuel pump is driven by an electric motor, which decouples the rotational speed of the pump from the rotational speed of the engine. This allows fuel delivery to be controlled primarily by varying the speed of the motor and may eliminate the need for fuel metering at the pump inlet and should minimize the quantity of fuel recirculated from the pump. The fuel pump can be simplified by eliminating an inlet metering valve.

Compressing fuel to pressures greater than 500 bar in a piston pump requires high peak torque as the pumping plunger is driven into the pumping chamber to pressurize the fuel. An electric motor with sufficient torque to meet this requirement is likely to be large, expensive and draw high power from the electrical system. To reduce the peak torque required by an electric motor-driven high-pressure piston-type fuel pump, an energy accumulator is configured to accumulate energy during the low force portion of the pump cycle corresponding to the intake stroke and return that energy to the pumping plunger during the high force portion of the pump cycle corresponding to the pumping stroke. This arrangement reduces the peak torque required from the motor and allows a smaller, less expensive and less energy intensive electric motor to drive the pump.

In the enclosed embodiment, a drive housing defines a drive chamber with a cam shaft supported within the drive chamber for rotation about a shaft axis. A circular cam is rigidly connected to the shaft. The circular cam has a circular outer periphery that defines a circular cam surface. This cam surface has a cam axis eccentric from said shaft axis. A cam roller surrounds the cam surface and has a sliding relationship to the cam surface. A cam follower surrounds the cam roller and includes a first driven surface and a second driven surface arranged on diametrically opposite sides of the cam roller. The cam follower has a first end adjacent the first driven surface and a second end adjacent the second driven surface. The cam follower has an outside surface guided on complementary surfaces of the drive housing for movement along a drive axis perpendicular to the shaft axis. Rotation of the cam shaft causes the cam follower to reciprocate along the drive axis between a first cam follower position and a second cam follower position. An energy accumulator is arranged at the second end of the cam follower. The energy accumulator includes a bias element between the second end of the cam follower and the drive housing, where movement of the cam follower from the first cam follower position to the second cam follower position compresses the bias element. Movement of the cam follower from the second cam follower position to the first cam follower position allowing the bias element to extend and return energy to the cam follower to assist movement of the cam follower from the second cam follower position to the first cam follower position to advance the plunger into the pumping chamber and pressurize fuel.

As used in this description and in the appended claims, the word “spring” means a resilient device, typically a helical metal coil, that can be pressed or pulled but returns to its former shape when released, used chiefly to exert constant tension or absorb movement as well as any “air spring; coil spring; helical spring; leaf spring; or torsional spring” but is not limited to a specific structure and is meant to cover all devices that are capable of performing the recited function. Bias element refers to any component or assembly configured to be compressed by force in a first direction to accumulate energy and extend in a second direction opposite the first direction where at least a portion of the energy absorbed is available during extension of the bias element when the force in the first direction is removed. An elastic or compressible component, or a sealed chamber filled with gas may serve as a bias element according to aspects of the disclosure.

According to aspects of the disclosure, a single piston fuel pump is positioned along a drive axis of the drive assembly, adjacent one end of the cam follower. A driven end of the pumping plunger receives force from the cam follower to advance the pumping plunger into the pumping chamber of the pump to compress fuel and push the compressed fuel through an outlet valve of the pump. In the disclosed motor driven fuel pump, a portion of the force needed to advance the pumping plunger into the pumping chamber is provided by the electric motor and another portion of the force is provided by force from the energy accumulator.

A variable speed electric motor is connected to the cam shaft to rotate the cam, which converts torque from the motor into reciprocal movement of the cam follower that is applied to the pumping plunger. The fuel pump may be connected to a fuel supply circuit including a common rail, and the fuel supply system is connected to an electronic control unit that receives input signals commensurate with fuel pressure in the common rail, engine speed, and cam rotation position. The electronic control unit delivers a control signal to the variable speed electric motor for rotating the cam at a speed different from the engine speed. In the disclosed motor driven fuel pump, the same quantity of fuel is pressurized for each cycle of the pumping plunger. The rotational speed of the cam corresponds to a pumping frequency of the fuel pump and the quantity of fuel pressurized by the motor driven fuel pump can be regulated by varying the rotational speed of the motor.

### BRIEF DESCRIPTION OF THE DRAWINGS

FIG. 1 is a longitudinal sectional view through a piston-type fuel pump with a single piston, and a motor-driven drive assembly incorporating the disclosed energy accumulator;

FIG. 2 is a cross-sectional view along the drive axis of the single piston fuel pump and drive assembly incorporating the disclosed energy accumulator; and

FIG. 3 is a longitudinal sectional view of FIG. 1 wherein the drive housing has been removed for an unobstructed view of the relationship between the pumping plunger, circular cam, cam follower, and energy accumulator.

### DETAILED DESCRIPTION

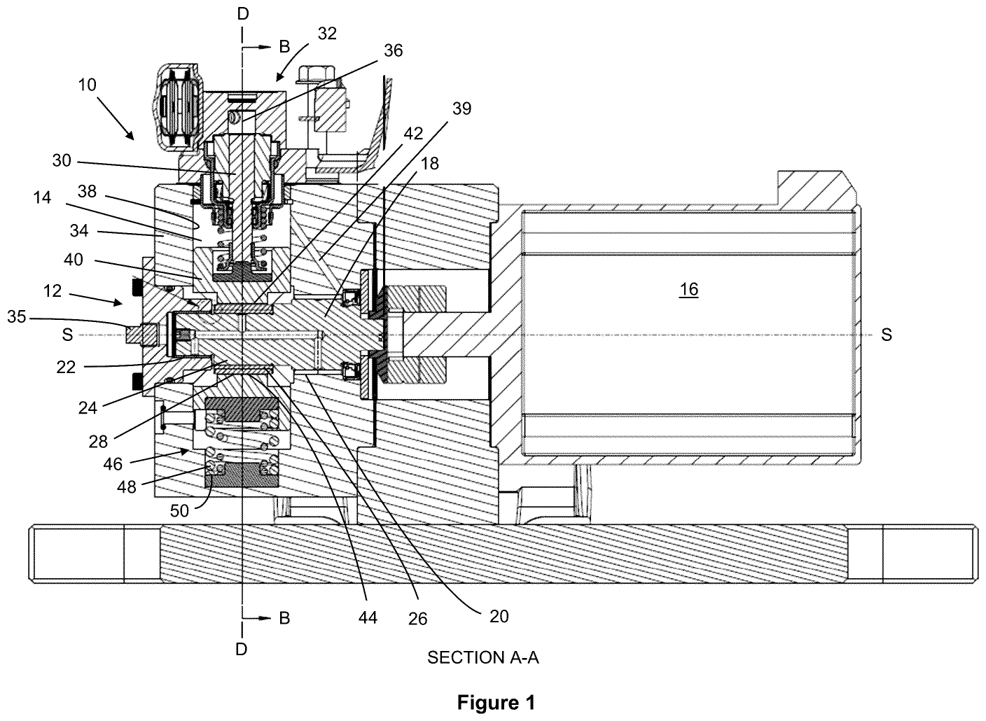

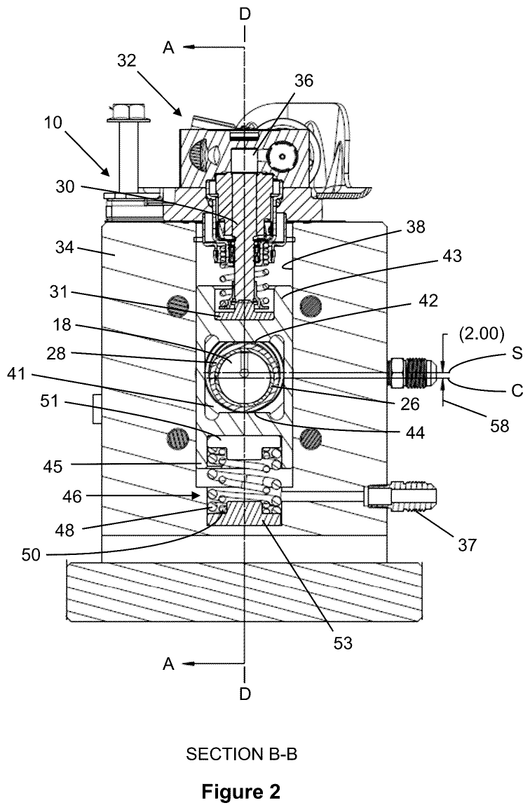

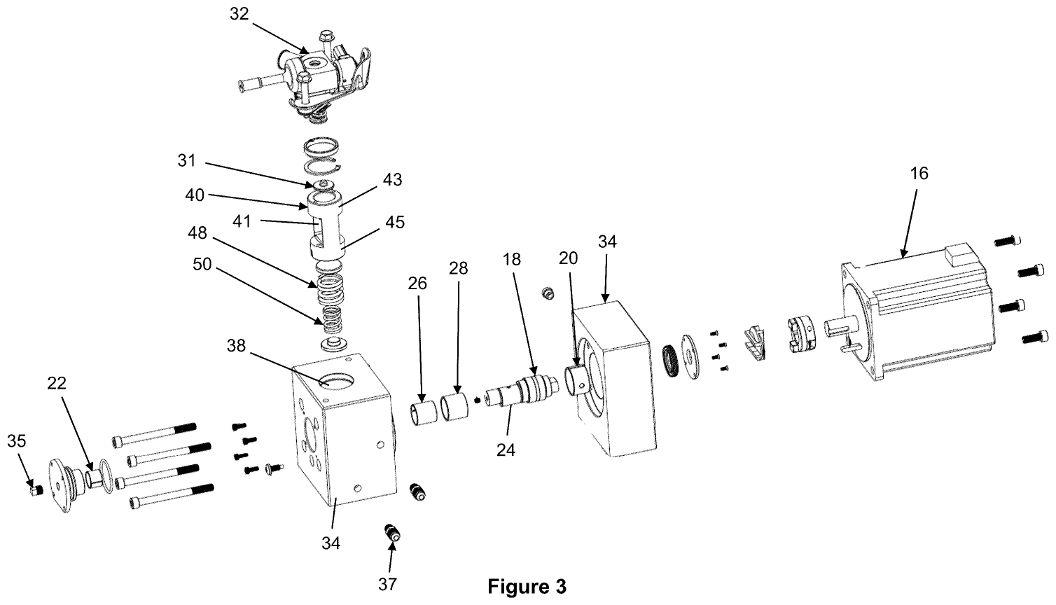

FIGS. 1-3 illustrate a disclosed embodiment of a motor driven high pressure fuel pump 10 according to aspects of the disclosure. FIG. 1 is a longitudinal sectional view through a disclosed embodiment of an electric motor-driven high pressure fuel pump 10 taken along line A-A of FIG. 2. FIG. 2 is a cross sectional view through the disclosed embodiment of FIG. 1, taken along line B-B of FIG. 1. The motor driven fuel pump 10 includes a variable speed electric motor 16, a drive assembly 12, and a single piston high-pressure fuel pump 32 coupled to be driven by the drive assembly 12. The drive assembly 12 includes an embodiment of an energy accumulator 46 arranged to accumulate energy during a low force part of the pumping cycle of the fuel pump 32 and return energy to the drive during a high force part of the pumping cycle of the fuel pump 32. The energy accumulator 46 is used to reduce a peak torque required to rotate the drive assembly 12 through the peak force part of the pumping cycle corresponding to advancing a pumping plunger in the pump to pressurize fuel, e.g., the “pumping stroke.” Reducing peak torque required from the variable speed electric motor 16 permits a smaller motor to be used and reduces the power consumed by the motor 16. A smaller motor with lower torque reduces the cost of the motor 16 and reducing the power consumed to drive the fuel pump 32 improves the overall efficiency of the engine platform receiving fuel from the motor driven high pressure fuel pump 10.

The disclosed drive assembly 12 includes a drive housing 34 that connects to and supports the variable speed electric motor 16 and the single piston high pressure fuel pump 32. The variable speed electric motor 16 may be a brushless direct current (BLDC) motor, the structure and function of which is well-understood by those skilled in the art. The variable speed electric motor 16 is controlled by a motor control circuit (not shown) as is known in the art. The motor control circuit is in communication with engine control systems such as an engine control unit (ECU) that will determine a demand for high pressure fuel from the motor driven high-pressure fuel pump 10. The motor control circuit will drive the motor 16 at a rotational speed that will produce a predetermined quantity of pressurized fuel corresponding to the demand. According to aspects of the disclosure, one embodiment of a single piston fuel pump 32 is configured to pressurize the same quantity of fuel during each pumping stroke, and the quantity of pressurized fuel delivered from the motor driven pump 10 per unit of time is determined primarily by the frequency at which the pump 32 is reciprocated by the motor 16. In a single piston fuel pump such as fuel pump 32, the frequency at which the pump is reciprocated has a fixed relationship to the rotational speed of the motor 16, so the quantity of fuel pressurized by the disclosed motor driven fuel pump is varied by controlling the rotational speed of the motor 16. This can simplify the structure of the pump 32 by eliminating the need for an inlet control valve that regulates the quantity of fuel pressurized by the pump 32 during each pumping stroke, as is required in fuel pumps driven by a shaft extending from the internal combustion engine. A simple inlet check valve can be used in the disclosed high pressure fuel pump 32, and the pumping chamber 36 of the pump 32 can be filled completely on each intake stroke of the pump (where the pumping plunger 30 is withdrawn from the pumping chamber 36). Fuel in the pumping chamber 36 is then pressurized and pumped through an outlet check valve to a common rail or other downstream receptacle for pressurized fuel by advancing the pumping plunger 30 into the pumping chamber 36.

The fuel pump 32 is configured to deliver fuel at pressures greater than 250 bar, which requires very high axial force on the pumping plunger 30 to advance the plunger 30 into the pumping chamber 36 and compress fuel to a pressure sufficient to open the outlet check valve of the pump against fuel pressure downstream of the pump. A single piston high pressure fuel pump 32 requires high force to advance the pumping plunger 30 into the pumping chamber 36 and requires substantially less force to withdraw the pumping plunger from the pumping chamber 36 during the part of the stroke where the pumping chamber 36 is filled with fuel. The pumping plunger 30 is advanced and withdrawn along a drive axis D-D extending through the pumping plunger 30, and a drive system needs to generate force along the drive axis D-D on a driven end of the pumping plunger 30 to overcome the back pressure on the outlet check valve and force fuel under pressure out of the pumping chamber 36. A disclosed drive assembly 12 is configured to convert rotation of a motor shaft into axial force along drive axis D-D sufficient to advance the pumping plunger 30 and pressurize fuel in the pumping chamber 36. The variable speed electric motor 16 must generate torque sufficient to overcome the peak counterforces imposed on the drive assembly 12, or the drive will not function. Peak counterforces in the drive assembly 12 coincide with the pumping stroke of the single piston pump 32.

The disclosed drive assembly 12 incorporates an energy accumulator 46 arranged to accumulate energy during a low-force portion of the pumping cycle corresponding to withdrawal of the pumping plunger 30 from the pumping chamber 36 and return the accumulated energy to the drive during a peak-force portion of the pumping cycle corresponding to advancing the pumping plunger 30 into the pumping chamber 36 to pressurize fuel. Return of energy to the drive during the peak-force portion of the pumping cycle reduces the overall peak-force required from the drive assembly 12 and reduces the maximum torque required to be generated by the motor 16. Reducing the maximum torque required from the motor 16 allows a reduction in the size and power consumption of the motor 16.

The disclosed drive assembly 12 employs a cam shaft 18 and cam 24 to convert rotation of the cam shaft 18 by the motor 16 into force on a driven end of the pumping plunger 30 along the drive axis D-D. A drive housing 34 supports the motor 16 in a position to couple the motor shaft with one end of the cam shaft 18, so torque generated by the motor 16 is applied to rotate the cam shaft 18. The configuration of a coupling between the motor shaft and the cam shaft 18 may be any known coupling sufficient to reliably deliver the torque generated by the motor 16 to the cam shaft 18. The cam shaft 18 is supported within the drive housing for rotation about a cam shaft axis S-S. In a disclosed embodiment, the cam shaft 18 is supported by two cam shaft bushings 20, 22. According to aspects of the disclosure, the drive housing 34 includes a lubricating oil inlet fitting 35 aligned with a lubricating oil passage in the cam shaft 18. Lubricating oil enters the drive housing through the inlet fitting 35 and passes through the lubricating oil passage in the cam shaft 18 to oil outlets at locations corresponding to the cam shaft bushings 20, 22 and a surface of the cam 24. Lubricating oil is allowed to circulate within the drive housing 34 to lubricate and cool the drive components. A lubrication oil return passage 37 will return lubricating oil to the lubricating oil system of the vehicle.

The drive housing 34 defines a drive chamber 14 surrounding the cam shaft 18. In the disclosed drive assembly 12, the drive chamber also defines a cam follower bore 38 aligned with the drive axis D-D. The cam follower bore 38 guides reciprocal movement of a cam follower 40 along the axis D-D. The drive housing 34 defines at least one oil passage 39 circulating oil delivered to a cam shaft bushing 20, 22 to lubricate the cam follower bore 38. As best seen in FIG. 2, the cam follower 40 defines an opening 41 through which the cam shaft 18 extends. According to aspects of the disclosure, the cam follower 40 includes first and second driven surfaces 42, 44 facing the cam 24 and arranged on diametrically opposed sides of the cam 24 along the drive axis D-D. The first and second driven surfaces 42, 44 are surfaces of the opening 41 through which the drive axis D-D passes. In the disclosed cam follower 40, the first and second driven surfaces 42, 44 are flat, planar surfaces, but the driven surfaces are not limited to this configuration. The cam follower 40 includes a cam follower body that extends from a first end 43 axially spaced along the drive axis D-D toward the pump 32 from the first driven surface 42 to a second end 45 axially spaced along the drive axis D-D in a direction opposite the pump 32 from the second driven surface 44. The body of the cam follower 40 extends between and connects the first end to the second end so that a fixed axial distance along drive axis D-D is maintained between the first and second driven surfaces 42, 44. In a disclosed embodiment, the cam follower 40 has a cylindrical outside surface and a cam follower bore 38 defined by the drive housing 34 has a complementary cylindrical inside surface. While a cylindrical bore 38 and cylindrical outside surface of a cam follower 40 are illustrated, the bore and follower are not limited to these configurations. Movement of the cam follower 40 is restricted to axial movement along drive axis D-D by contact between the cam follower outside surface and the cam follower bore 38 inside surface. According to aspects of the disclosure, guided movement of the cam follower 40 substantially eliminates off axis forces imposed on the pumping plunger 30 of the pump 32. Lubricating oil is circulated to lubricate the interface of the cam follower 40 and cam follower bore 38.

According to the disclosed embodiment, a cam roller 28 surrounds the cam 24 includes a cam bushing 26 on an inside diameter. The cam bushing 26 is selected to have low sliding friction on the surface of the cam 24, particularly when lubricated with oil circulating in the drive chamber 14. The cam roller 28 and bushing 26 is selected to have the strength and durability to transfer force from the cam 24 to the cam follower 40. The cam roller 28 bushing 26 rotates on the surface of the cam 24 and may slide relative to the first and second driven surfaces 42, 44 of the cam follower 40. One advantage of the disclosed configuration of the cam follower 40 is that the first and second driven surfaces 42, 44 are maintained at a predetermined axial distance from each other and very close to the outside surface of the cam roller 28. The relationship between the driven surfaces 42, 44 and the outside surface of the cam roller 28 may be described as a “slip fit” where the parts have minimal sliding resistance, but very little distance is left between the parts along drive axis D-D. This ensures that force is efficiently transmitted from the cam 24 to the cam follower 40 via the cam roller 28. As seen in FIG. 2, the cam follower 40 defines an opening 41 through which the cam shaft 18 extends. The first (upper) end 43 of the cam follower 40 defines a recess or pocket that receives the driven end of the pumping plunger 30. A piston interface plate 31 rests on the bottom of the pocket and includes a central projection that extends upward to contact the driven (bottom) end of the pumping plunger 30. Upward force on the pumping plunger 30 is transferred from the cam 24 through the cam roller 28, first end 43 of the cam follower 40, and piston interface plate 31. A flange is secured to the lower end of the pumping plunger 30 and a plunger return spring is biased between the flange and the pump to bias the pumping plunger 30 away from the pumping chamber 36 and toward the cam 24. As is known in the art, the fuel pump 32 incorporates a seal surrounding the pumping plunger 30 to isolate fuel circulating in the fuel pump 32 from lubricating oil circulating in the cam follower bore 38.

An energy accumulator 46 according to aspects of the disclosure is arranged along the drive axis D-D diametrically opposite the pump 32. The disclosed embodiment of an energy accumulator 46 includes a bias element of two concentric springs 48, 50 biased between upper and lower spring plates 51, 53, with the upper spring plate 51 received in a recess or pocket defined by the second end of the cam follower 40. The energy accumulator springs 48, 50 are compressed when the cam 24 acts on the second driven surface 44 to move the cam follower 40 away from the pump 32, allowing the pumping plunger 30 to be retracted from the pumping chamber 36 by the plunger return spring. Alternative configurations of a bias element for use in an energy accumulator 46 can be used for the function of accumulating energy during the low force portion of the pumping cycle and returning energy to the drive during a high force portion of the pumping cycle. Alternative bias elements may include elastic or compressible materials, or gas-filled cylinders or chambers (not shown). As shown in FIG. 2, the cam 24 has a circular cam surface that has a center C offset from the axis of rotation S of the cam shaft. This offset produces movement of the cam follower 40 along drive axis D-D between a first position where the pumping plunger 30 is advanced into the pumping chamber 36 and a second position where the pumping plunger 30 is withdrawn from the pumping chamber 36. In the disclosed energy accumulator 46, springs 48, 50 are compressed as the eccentric portion of the cam 24 moves the cam follower 40 to the second position (downward in FIGS. 1 and 2). Movement of the cam follower 40 to the first position (upward in FIGS. 1 and 2) allows the spring 48, 50 to extend and return energy to the cam follower 40 to assist the motor 16 in advancing the pumping plunger into the pumping chamber 36 to pressurize fuel.

The cam shaft 18 is supported within drive chamber 14 by a first shaft bushing 20 and a second shaft bushing 22 for rotation about a shaft axis S-S. The piston-type fuel pump 32 includes a pumping plunger 30 that is advanced into a pumping chamber 36 to pressurize fuel and retracted from the pumping chamber 36 to draw a fresh charge of fuel into the pumping chamber 36. This pumping cycle is repeated for each revolution of the cam shaft 18 and cam 24. The circular cam 24 is rigidly connected to the cam shaft 18, and in the disclosed embodiment is integrally formed with the cam shaft 18. The cam 24 circular outer periphery defining a circular cam surface, said cam surface having a cam surface center C eccentric from the cam shaft axis S-S of rotation a predetermined distance 58. The distance 58 corresponds to one half the distance along the pumping axis D-D between the first cam follower position and the second cam follower position. In one embodiment, distance 58 may be 2 mm and the stroke of the cam follower 40 along the drive axis D-D is 4 mm. FIGS. 1 and 2 illustrate the drive assembly 12 and pump 32 in the second cam follower position corresponding to a retracted position of the pumping plunger 30 and a compressed condition of the energy accumulator springs 48, 50. The disclosed drive includes a circular cam roller 28 disposed in a sliding relationship surrounding the circular cam 24. The substantially cylindrical cam roller 28 is annularly press-fit with the cam surface bushing 26 so the cam roller 28 and cam bushing 26 are connected to move together with the bushing 26 sliding on the outside surface of the cam 24 lubricated by oil delivered to the cam surface through the cam shaft 18 as previously described. The cam roller 28 slides on the cam surface and rotates freely relative to the cam shaft 18.

The cam follower 40 surrounds the cam roller 28 and includes a first driven surface 42 and a second driven surface 44. The first and second driven surfaces 42, 44 are arranged on diametrically opposite sides of the cam roller 28. The cam follower 40 has a first end 43 outward of said first driven surface 42 along drive axis D-D and a second end 45 axially outward of said second driven surface 44 along drive axis D-D. In a disclosed embodiment, the cam follower 40 has a cylindrical outer surface guided on a complementary inside surface of the cylindrical cam follower bore 38 defined by the drive housing 12 for movement along the drive axis D-D perpendicular to said shaft axis S-S. Rotation of the cam shaft 18 causes the cam follower 40 to reciprocate along said drive axis D-D between the first cam follower position corresponding to an advanced position of the pumping plunger 30 and the second cam follower position corresponding to the withdrawn or retracted position of the pumping plunger 30.

An energy accumulator 46 is arranged at the second end of the cam follower 40, with the energy accumulator 46 having a bias element comprising at least one spring 48, 50 biased between the second end of the cam follower 40 and the drive housing 12. An accumulator bore extending along drive axis D-D from the cam follower bore 38 contains the energy accumulator 46 diametrically opposed the pumping plunger 30 and below the cam shaft 18. Movement of the cam follower 40 from the first cam follower position to the second cam follower position compresses the at least one spring 48, 50 and movement of the cam follower 40 from the second cam follower position to the first cam follower position allows the at least one spring 48, 50 to extend, thereby returning energy from the springs 48, 50 to the cam follower 40 to assist movement of the cam follower 40 from the second cam follower position to the first cam follower position. Movement of the cam follower 40 from the second cam follower position (shown in FIGS. 1 and 2) to the first cam follower position corresponds to the pumping stroke of the pump 32 and energy returned to the cam follower by the energy accumulator 46 reduces the peak torque required from the motor 16 to move the cam follower 40 and pumping plunger 30 to the cam follower first position.

In the disclosed energy accumulator 46, the second end of the cam follower 40 bears on one of two return spring plates 51, 53 arranged to compress the concentric coil springs 48, 50 of the energy accumulator 46. The energy accumulator 46 is positioned diametrically opposite to the pumping plunger 30, so the cycle of the energy accumulator 46 has an opposite phase to the cycle of the pumping plunger 30. The disclosed energy accumulator 46 includes two concentric coil springs 48, 50 arranged to be compressed during the part of the pumping cycle where the plunger 30 is being withdrawn from a pumping chamber 36. During the part of the pumping cycle where the pumping plunger 30 is advanced into the pumping chamber 36, the coil springs 48, 50 extend and return energy to the pumping plunger 30, specifically by applying upward force to the circular cam 24 surface via the cam follower 40. The energy returned to the pumping plunger 30 by the energy accumulator 46 reduces the peak torque that must be supplied by the electric motor 16 by accumulating energy from a low torque portion of the pump cycle, when the cam follower 40 is moved toward the second cam follower position, and returning energy to the pumping plunger 30 during a high torque portion of the pump cycle, when the cam follower 40 is moved to the first cam follower position.

According to aspects of the disclosure, the energy accumulator 46 is configured to generate a force along drive axis D-D toward the pumping plunger 30 corresponding to between ⅓ and ⅔ of a force required to advance the pumping plunger 30 into the pumping chamber 36 to pressurize fuel. In a preferred embodiment, the energy accumulator 46 generates a force along drive axis D-D during movement of the cam follower 40 from the second position to the first position corresponding to approximately ½ the force required to advance the plunger 30 into the pumping chamber 36 to pressurize fuel. This relationship between the force returned to the cam follower 40 and the force required to advance the plunger 30 to pressurize fuel reduces the peak torque required from the motor 16 by at least 30%. This reduction in peak torque allows a meaningful reduction in the size and energy consumption of the motor 16 for the motor driven high pressure fuel pump 10.

The disclosed drive assembly can be used to drive a single piston fuel pump 32 similar in structure and function, to that disclosed in commonly owned U.S. Pat. No. 8,579,611 the entire contents of which are herein incorporated by reference. The single piston fuel pump 32 includes a pump housing 34 defining a pumping chamber 36, an inlet valve that feeds low pressure fuel to the pumping chamber 36, a plunger sleeve biased toward the pumping chamber 36 by a load ring biased between a sleeve retainer and a lower end of the pumping sleeve. The plunger sleeve has a seal face at an upper end which bears on and seals against a seal surface at the end wall of the mounting bore on the pump housing 34. The pumping plunger 30 reciprocates in the plunger sleeve toward and away from the pumping chamber 36. A plunger sleeve retainer is secured to the pump housing 34 and axially supports the sleeve via the load ring. A plunger return spring is captured between a spring seat on a flange at the outer end of the plunger 30 and a shoulder on the sleeve retainer. The load ring is situated between the sleeve retainer and the sleeve, urging the sleeve toward the pump housing 34 with sufficient force to maintain concentricity of the plunger 30 within the sleeve and sealingly press the sealing face of the sleeve against the sealing surface at the end wall of the bore on the pump housing 34. Other piston pump configurations may be employed.

Among the benefits and improvements disclosed herein, other objects and advantages of the disclosed embodiments will become apparent from the following wherein like numerals represent like parts throughout the figures. Detailed embodiments of an energy accumulator and motor driven drive for a high pressure fuel pump, are disclosed; however, it is to be understood that the disclosed embodiments are merely illustrative of the invention that may be embodied in various forms. In addition, each of the examples given in connection with the various embodiments of the invention are intended to be illustrative, and not restrictive.

Throughout the specification and claims, the following terms take the meanings explicitly associated herein, unless the context clearly dictates otherwise. The phrase “in some embodiments” as used herein does not necessarily refer to the same embodiment(s), although it may. The phrases “in another embodiment” and “in some other embodiments” as used herein do not necessarily refer to a different embodiment, although it may. Thus, as described above, various embodiments may be readily combined without departing from the scope or spirit of the invention.

In addition, as used herein, the term “or” is equivalent to the term “and/or,” unless the context clearly dictates otherwise. The term “based on” is not exclusive and allows for being based on additional factors not described unless the context clearly dictates otherwise. In addition, throughout the specification, the meaning of “a,” “an,” and “the” include plural references. The meaning of “in” includes “in” and “on.”

Further, the terms “substantial,” “substantially,” “similar,” “similarly,” “analogous,” “analogously,” “approximate,” “approximately,” and any combination thereof mean that differences between compared features or characteristics is less than 25% of the respective values/magnitudes in which the compared features or characteristics are measured and/or defined.

What is claimed:

1. A drive assembly for a piston-type fuel pump, said drive assembly comprising:
a drive housing defining a drive chamber;
a cam shaft supported within said drive chamber for rotation about a shaft axis;
a circular cam rigidly connected to the cam shaft, said cam having a circular outer periphery defining a circular cam surface, said cam surface having a cam surface axis eccentric from said shaft axis;
a cam roller having a sliding relationship to said cam surface;
a cam follower surrounding the cam roller and including a first driven surface and a second driven surface, said first and second driven surfaces arranged on diametrically opposite sides of said cam roller, said cam follower having a first end axially outward of said first driven surface and a second end axially outward of said second driven surface, said cam follower having an outside surface guided on a complementary surface of said drive housing for movement along a drive axis perpendicular to said shaft axis, rotation of said cam shaft causing said cam follower to reciprocate along said drive axis between a first cam follower position and a second cam follower position;
an energy accumulator arranged at the second end of the cam follower, said energy accumulator comprising at least one bias element between the second end of the cam follower and the drive housing, movement of the cam follower from the first cam follower position to the second cam follower position compressing said at least one bias element and movement of the cam follower from the second cam follower position to the first cam follower position allowing the at least one bias element to extend, thereby returning energy from the bias element to the cam follower to assist movement of the cam follower from the second cam follower position to the first cam follower position.

2. The drive assembly of claim 1, wherein the at least one bias element comprises at least one coil spring.

3. The drive assembly of claim 1, wherein said cam follower has a cylindrical outside surface and said drive housing defines a cam follower bore aligned with said drive axis and including a cylindrical cam follower bore inside surface complementary to the cylindrical outside surface of said cam follower.

4. The drive assembly of claim 1, wherein the cam follower defines an opening and the cam shaft extends through said opening, said cam shaft supported for rotation by first and second bushings on opposite sides of the cam follower.

5. The drive assembly of claim 4, wherein the first driven surface and the second driven surface are planar surfaces on opposite ends of the opening, said drive axis extending through the first and second driven surfaces.

6. The drive assembly of claim 4, wherein the first and second driven surfaces are planar surfaces on opposite ends of the opening spaced apart from each other along the drive axis a distance equal to an outside diameter of the cam roller.

7. The drive assembly of claim 4, wherein said cam follower includes sides connecting the first and second ends of the cam follower, said sides defining a lateral width of the opening, said lateral width being greater than the outside diameter of the cam roller by at least the distance between the shaft axis and the cam surface axis.

8. The drive assembly of claim 4, wherein the cam shaft defines an oil flow passage along said shaft axis, said oil flow passage including radial portions directing oil to the first and second bushings, said drive housing defining at least one oil flow passage to circulate lubricating oil delivered to one of the first or second bushings to a portion of a cam follower bore proximate the cam follower first end, the cam follower bore having a bore inside surface complementary to an outside surface of the cam follower.

9. The drive assembly of claim 6, wherein said drive housing includes an oil inlet communicating with said oil flow passage, said drive housing defines a drive chamber surrounding the cam shaft and cam follower and said drive housing includes an oil return passage.

10. A motor driven high pressure fuel pump comprising
the drive assembly of claim 1,
a variable speed electric motor coupled to rotate said cam shaft; and
a piston type fuel pump connected to said drive housing, said fuel pump comprising a pumping plunger arranged to reciprocate on said drive axis between a plunger first position advanced into a pumping chamber and a plunger second position retracted from the pumping chamber,
wherein said pumping plunger is moved from the plunger second position to the plunger first position as the cam follower moves from the cam follower second position to the cam follower first position.

11. The motor driven high pressure fuel pump of claim 10, wherein the plunger is biased toward the plunger second position and received in a recess defined by the first end of the cam follower.

12. The motor driven high pressure fuel pump of claim 10, wherein a first force along the drive axis is required to move the pumping plunger from the plunger second position to the plunger first position to compress fuel in the pumping chamber and the energy returned to the cam follower generates a second force between ⅓ and ⅔ the first force.

13. The motor driven high pressure fuel pump of claim 10, wherein a quantity of fuel pressurized by the pump is regulated by varying the rotational speed of the variable speed electric motor.

14. A method of returning energy to a cam in a drive assembly, said method comprising:
supporting a circular cam surface on a cam shaft having a cam shaft axis of rotation, said circular cam surface have a cam axis of rotation offset from the cam shaft axis of rotation;
coupling a cam follower to the circular cam surface to that the cam follower is moved along a drive axis perpendicular to the cam shaft axis of rotation between a first cam follower position and a second cam follower position;
connecting an energy accumulator to the cam follower to receive axial force from the cam follower as the cam follower moves from the first cam follower position to the second cam follower position,
wherein said axial force received by said energy accumulator compresses a bias element and said energy accumulator returns energy to the cam by extension of the bias element as the cam follower moves from the second cam follower position to the first cam follower position.
